(19) United States
(12) Patent Application Publication
(10) Pub. No.: US 2026/0310619 A1
(43) Pub. Date: Oct. 8, 2026

(54) ALIGNMENT MARKERS FOR ALIGNING DL FLITS TO ETHERNET CODEWORDS

(71) Applicants: ATI Technologies ULC, Markham (CA); Xilinx, Inc., San Jose, CA (US)

(72) Inventors: David Alan Brown, Ontario (CA); Shawn David Nicholl, Ottawa (CA); Alexandros Vasileiou, Edinburgh (GB)

(73) Assignees: ATI Technologies ULC, Markham (CA); Xilinx, Inc, San Jose, CA (US)

(21) Appl. No.: 19/391,826

(22) Filed: Nov. 17, 2025

Related U.S. Application Data
(60) Provisional application No. 63/784,861, filed on Apr. 7, 2025.

(51) Int. Cl. G06F 13/36

(52) U.S. Cl. CPC G06F 13/36; G06F 2213/40

(57) ABSTRACT

Systems and methods for aligning flits including an apparatus or device including a first circuit corresponding to a data link layer, and a second circuit corresponding to a physical layer, the second circuit including a first sublayer, a second sublayer located between the first sublayer and an interconnect link, and an interface communicatively coupling the first sublayer to the second sublayer for transmission of code blocks between the first and second sublayers during data communications between the link partners, the code blocks align a first datagrams of the first sublayer to a second datagrams of the second sublayer based on alignment markers of the second datagrams. In a transmit direction, the first sublayer sends first code blocks to the second sublayer to indicate when to overwrite the alignment markers. In a receive direction, the second sublayer sends second code blocks to indicate when the first datagrams include alignment markers.

### CROSS-REFERENCE TO RELATED APPLICATIONS

The present application claims priority to and benefit of U.S. Provisional Patent Application No. 63/784,861, filed Apr. 7, 2025, and entitled “Alignment Markers for Aligning DL Flits to Ethernet Codewords,” the entirety of which is herein incorporated by reference.

### BACKGROUND

Accelerators are computing components that are commonly used to perform a broad range of demanding processing tasks such as, for example, computations, model inferencing, deep learning, rendering, data processing, cryptocurrency mining, video encoding/decoding, and other applications. For example, data centers can include multiple servers housing multiple accelerators capable of being tasked with handling these processing tasks. Many applications require real-time or near real-time results, which may be achieved by multiple processing nodes working in parallel through data communication and resource sharing to perform common tasks. Accordingly, providing high-speed, low-latency communications over an interconnect fabric between accelerators may be desirable to capitalize on the full potential of the accelerators in processing devices.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings make apparent to those skilled in the art how embodiments of the disclosure may be practiced.

FIG. 1 illustrates a block diagram of an exemplary system, according to some embodiments.

FIG. 2 illustrates a diagram of an exemplary system, according to some embodiments.

FIG. 3 illustrates a block diagram of an exemplary system, according to some embodiments.

FIG. 4 illustrates a block diagram of an exemplary computing system configured to implement the techniques described herein, according to some embodiments.

FIG. 5 illustrates an example block diagram of a portion of an exemplary communication system for aligning the flits to codewords, according to some embodiments.

FIG. 6 illustrates an example block diagram of a portion of communication system for aligning the flits to codewords, according to some embodiments.

FIG. 7 illustrates an exemplary datagram, according to some embodiments.

FIG. 8 illustrates a flow diagram of a method, according to some embodiments.

### DETAILED DESCRIPTION

Described herein are systems and methods for aligning flow control units (“flits”) to codewords for data transmission between network devices over an interconnect link in accordance with a communication protocol, which may in some embodiments be used to improve efficiency and reliability in data communications between the network devices. For example, the flit alignment to the codewords may be implemented to ensure that data transmitted over multiple lanes arrives in sync and to detect transmission error, among other benefits as will be further described herein. The flit alignment may be achieved by aligning each flit such that the boundary of the flit aligns into a codeword based on the existing alignment markers. The flit alignment may be implemented at an interface device or circuit, which may, in some embodiments, encode data messages received as flits into the codewords and may establish a hardware connection with another computing node to transmit the encoded messages as codewords over the physical link.

The network devices may in some embodiments include a layered architecture, which may be implemented as a communication stack embodied as any suitable combination of hardware, software, or firmware in one or more circuits of the network devices such as, for example, the interface device. In some non-limiting examples, the interface device may include special-purpose circuitry having hardware designed to perform operations including the flit to codeword alignment in accordance with the techniques described herein. The flits may, in some embodiments, be encoded into the codewords based on the existing alignment markers at one or more layers of the communication stack of the network devices. In some embodiments, the layered architecture can include a physical layer designed to implement the flit alignment as described herein. In some embodiments, the layered architecture can further include a data link layer designed to implement the flit alignment as described herein.

The physical layer may include one or more sublayers including a reconciliation sublayer (RS) and a physical coding sublayer (PCS), among other layers, which may be implemented to perform the flit alignment. The RS may adapt the flit format into a stream of blocks, which can be received from a data layer of the layered architecture. In the transmit (Tx) direction, the RS may encode the flits into codewords for transmission to the PCS over an interface. The RS may indicate to the PCS when the codeword alignment markers may be overwritten at the PCS in the Tx direction, which may in some embodiments be implemented by the RS sending start flit code sequences to the PCS at an appropriate rate as a function of data rate to indicate to the PCS to overwrite the alignment markers. The PCS may overwrite the alignment markers based on instructions from the RS in the transmit direction. In the receive (Rx) direction, the PCS may decode codewords into flits for transmission to the RS over an interface. The RS may in some embodiments indicate to the PCS when the alignment markers are received in the Rx direction. The RS may also indicate to the data layer (DL) the start of receive flits, including if the received flit is a control flit or a data flit.

RS may in some embodiments transmit a stream of data corresponding to data blocks or control blocks in the Tx direction and the RS may in some embodiments expect to receive a flow of data blocks or control blocks in the Rx direction. The RS may not include start or termination blocks demarking the beginning or end of the flit in the blocks. Instead, the RS may transmit a flit code sequence, which may include a fixed number of code blocks. For example, the RS may receive flits each having 20, 256-bit blocks (640 bytes), and the RS may convert the flits into a flit code sequence having 80 units of 64B/66B blocks. A flit code sequence may have all data blocks. Alternatively, a flit code sequence may have all control blocks. In some embodiments, data flit code sequences (e.g., corresponding to all data blocks) may originate and terminate at the DL. In some embodiments, control flit code sequences (e.g., formed of all control blocks) may originate and terminate at the RS.

Flits from the DL may include no operation (NOP) flits or payload flits. In some embodiments, some flits received by the RS from the DL may be NOP flits, which do not include payload data. Instead, NOP flits may be a control flit that may be utilized for link fault signaling, to indicate when to overwrite alignment markers in the Tx direction, to indicate when a flit contains alignment markers in the Rx direction, and for idle transmission or reception. Idle transmission may be utilized for rate matching or in response to receiving remote faults. In some embodiments a flit may carry alignment markers and the remainder of the flit may be idle filled.

In the Tx direction, the RS may receive data flits from the DL having a first format and the RS may convert the data into a second format for transmission over the interconnect. The second format may, in some embodiments, be a start flit code sequence. The start flit code sequence may include idle start flit code sequences and fault start flit code sequences. These start flit code sequences may be transmitted RS to PCS to indicate the start of a flit code sequence, and to indicate to the PCS when to overwrite an alignment marker. In the Rx direction, the RS may utilize alignment market (AM) flit code sequences to determine receive flit alignment. The AM flit code sequence may include a certain number of control blocks, the first n blocks may be a first block type having data bytes set to a first value, and the remaining control blocks may be a second block type. In some embodiments, each control block may be a 64B/66B control block. In some embodiments, each control code (in the 64B/66B control block) may indicate idle (/I/). It is to be appreciated that the value of n may be a function of the length of the alignment markers, which may depend on the PCS and data rate. In the Rx direction, the RS may, in some embodiments, send the AM flit code sequences responsive to the PCS having achieved alignment lock. That is, in the Rx direction, the RS may send the AM flit code sequences when the PCS receives or expects to receive a codeword containing the alignment marker. Accordingly, in the Rx direction, the AM flit code sequence sent by the RS may replace the flit containing the alignment marker.

In some prior approaches, the transmit PCS inserts alignment markers on each PCS lane to enable the receiver device to identify and deskew the lanes for proper data reception and reassembly of the data stream from each individual lane into a single stream and encoded into a flit. The flit alignment techniques described herein utilize the RS to control the flit to codeword alignment and, instead of the PCS, the RS determines when the alignment marker is sent, using the flit code sequences sent at the appropriate rate, so that the flit may be properly packed into a respective codeword. The flit alignment techniques described herein may improve upon prior approaches that utilize the PCS to insert the alignment markers because the PCS may not be aware of the DL flit alignment. By having the RS control the flit to codeword alignment, the flit alignment techniques described herein ensure that the flit fits within the codeword’s existing alignment markers. In addition, the flit alignment techniques described herein may support reduced codeword interleave, which may improve latency for FEC decode in the receive direction, and may result in higher post FEC BER.

Some prior approaches may use a sideband communication channel to indicate when to place alignment markers. However, some interfaces may not be able to accommodate a sideband. For example, certain arrangements between chips or chiplets may not be able to accommodate the sideband in the circuitry. By enabling the 64B/66B interface between the RS and the PCS with no sideband, the flit alignment techniques described herein may be utilized to align DL flits to codewords that optimize latency and replay bandwidth in system architectures that may not easily accommodate sidebands in the circuitry to indicate when to insert the alignment markers or back propagating the PCS insertion timing to the RS/DL.

Among those benefits and improvements that have been disclosed, other objects and advantages of this disclosure will become apparent from the following description taken in conjunction with the accompanying figures. Detailed embodiments are disclosed herein; however, it is to be understood that the disclosed embodiments are merely illustrative of the disclosure that may be embodied in various forms. In addition, each of the examples given regarding the various embodiments described herein are intended to be illustrative, and not restrictive.

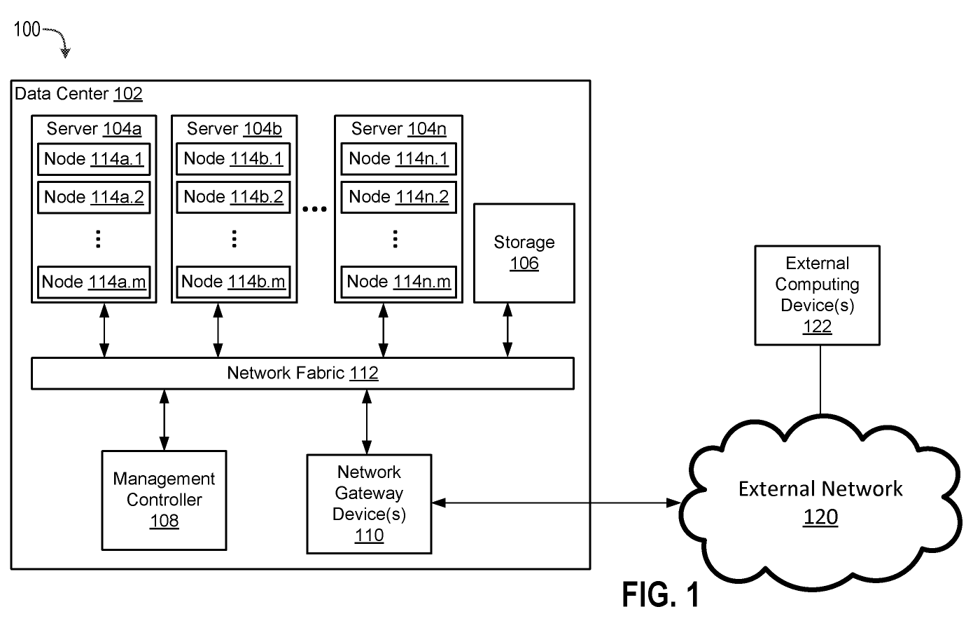

FIG. 1 illustrates a block diagram of an exemplary system 100, according to some embodiments. The system 100 may be configured to implement some techniques described herein, although other systems are possible.

Referring to FIG. 1, the system 100 may include a data center 102. The data center 102 may be communicatively connected to an external network 120. The data center 102 may, for example, receive processing requests from external computing device(s) 122 via the external network 120. The data center 102 may be utilized to perform any of a plurality of processing or rendering tasks based on one or more data sets using at least some portion of a processing and rendering resources of data center 102. For example, a user of an external computing device 122 may send a processing request to data center 102 via external network 120, and the data center 102 may utilize one or more of the processing resources of data center 102 to fulfill the user request. It should be appreciated that FIG. 1 is intended neither to be a depiction of necessary components for a data center or components thereof to operate in accordance with the principles described herein, nor a comprehensive depiction. The system 100 can include additional components, omit one or more of the described components, multiple instances of a component even if only one instance is shown in FIG. 1), and/or can be organized in other suitable manners.

In some examples, the data center 102 may include a plurality of servers 104, storage device(s) 106, management controller 108, and a network gateway device(s) 110. Each of the plurality of servers 104, storage device(s) 106, management controller 108, and network gateway device(s) 110 may be communicatively coupled with one or more other components of the data center 102 over a network fabric 112.

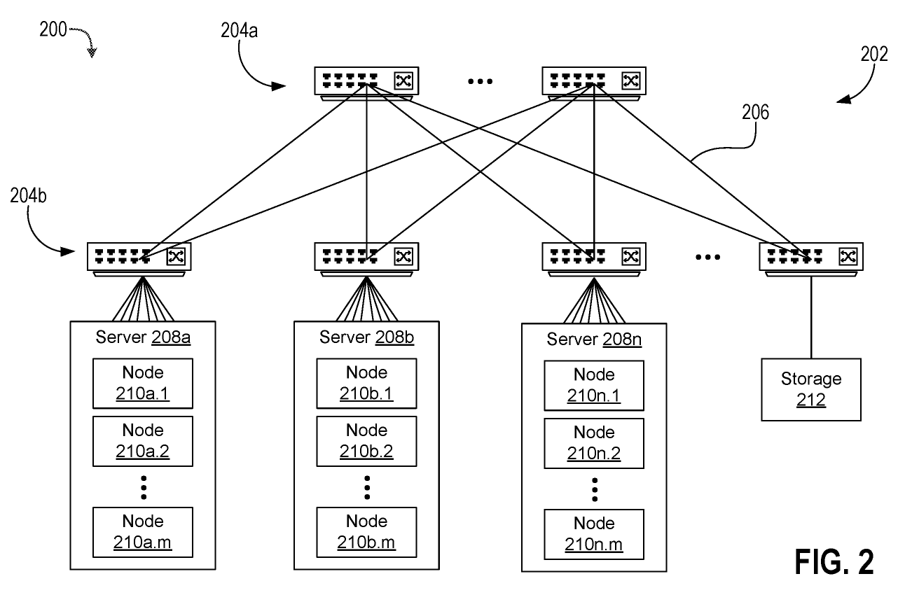

The plurality of servers 104 may include servers 104a, 104b, through 104n. Each server 104a, 104b, through 104n may include a plurality of processing nodes 114, each of the plurality of processing nodes 114 may include one or more processing resources for performing processing or rendering tasks, as will be further described herein. While the examples of FIGS. 1 and 2 depict servers 104 that include processing nodes 114, in other embodiments each processing nodes 114 may include one or multiple processing and storage resources and may be directly connected to network fabric 112, such that there may not be any element considered to be a server 104 or such that each processing node 114 may be considered a separate server 104.

The storage device(s) 106 may include a variety of computer-readable media for storing data, programs, instructions, etc. for use by the plurality of processing nodes 114 of the plurality of servers 104. For example, storage device(s) 106 can include any combination of random access memory (RAM), read only memory (ROM); electronically erasable programmable read only memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the plurality of processing nodes 114. The storage device(s) 106 can include computer-storage media in the form of volatile and/or nonvolatile memory. The storage device(s) 106 may be removable, non-removable, or any combination thereof. For example, storage device(s) 106 can include hardware devices such as hard drives, solid-state memory, optical-disc drives, and the like.

The management controller 108 may be connected to each of the plurality of servers 104, storage device(s) 106, network gateway device(s) 110. Each of the plurality of servers 104 (shown as servers 104a, 104b, through 104n) may include a plurality of processing nodes 114 (shown as nodes 114a.1, 114a.2, through 114a.m, nodes 114b.1, 114b.2, through 114b.m, and nodes 114n.1, 114n.2, through 114n.m). The management controller 108 may include a combination of hardware, software and firmware to assist in orchestration of processing operations using the plurality of processing nodes 114 at each of the plurality of servers 104, which may include controlling storage, communications, timing, frequency, etc. within the data center 102 and/or between parts of the plurality of servers 104 and other systems (e.g., external client devices).

The network gateway device(s) 110 may communicatively connect data center 102 to external network 120, which may be used to enable external computing device(s) 122 to send processing requests to data center 102, and to receive data from data center 102 responsive to the request via external network 120. For example, network gateway device(s) 110 may receive a processing request from a user of an external computing device 122 via external network 120, and the network gateway device(s) 110 may transmit the request to management controller 108 to orchestrate fulfillment of the request using one or more of the plurality of processing nodes 114 of the plurality of servers 104 in accordance with the user request.

FIG. 2 illustrates a diagram of an exemplary system 200, according to some embodiments. The system 200 may be configured to implement some techniques described herein, although other systems are possible. System 200 may be implemented with any combination of components and/or subsystems of system 100.

It should be appreciated that FIG. 2 is intended neither to be a depiction of necessary components for a data center or components thereof to operate in accordance with the principles described herein, nor a comprehensive depiction. The system 200 can include additional components, omit one or more of the described components, multiple instances of a component even if only one instance is shown in FIG. 2), and/or can be organized in other suitable manners.

In some examples, system 200 may include a network fabric 202 coupled to one or more components including a plurality of servers 208 (shown as servers 208a, 208b, through 208n). The one or more other components may include any of the components or sub-systems of system 100. Each of the plurality of servers 208 may include a plurality of nodes 210 for fulfilling

processing tasks received from, for example, management controller 108 of FIG. 1. For example, referring to FIG. 2, server 208a may include nodes 210 (shown as nodes 210a.1, 210a.2, through node 210a.m). For example, the one or more other components of system 200 may include storage 212, which may be connected to network fabric 202 to enable the plurality of servers 208 and the plurality of processing nodes 210 of each of the plurality of servers 208 to store and retrieve data from storage 212.

The network fabric 202 may include a plurality of switches 204 interconnected together via one or more interconnect links 206 such that each switch 204 of the plurality of switches 204 may be connected to one or more other components of system 200. In some examples, the plurality of switches 204 of network fabric 202 may include spine switches 204a and leaf switches 204b. The spine switches 204a may be used to interconnect one or more leaf switches 204b. The leaf switches 204b may interconnect one or more servers to the spine switches 204a. The leaf switches 204b may serve as an access switch that aggregates data traffic from servers and forwards the data to the spine switches 204a for transmission to its intended destination. The leaf switches 204b may be referred to as top-of-rack switches, and which may be used to connect to the plurality of processing nodes 210 of a given server 208 to enable data transmission and resource sharing between the plurality of processing nodes 210 of the given server 208 and/or data transmission and resource sharing between nodes 210 of respective servers of the plurality of servers 208.

The interconnect links 206 be used for serialized data transmission between at least two components of system 200 over one or more lanes at a defined serial rate. In some examples, one or more of the interconnect links 206 may be defined in accordance with a 200 Gigabit per second serial communication standard. In some embodiments the one or more of the interconnect links 206 may be defined for 1, 2, or 4 serial lanes capable of running at a serial rate of 212.5 Gbps. For example, the interconnect links 206 may be designed in accordance with 200GBASE-KR1/CR1, 400GBASE-KR2/CR2, and/or 800GBASE-KR4/CR4 standards. In some examples, one or more of the interconnect links 206 may be defined in accordance with 100 Gigabit communication standard. In some embodiments the one or more of the interconnect links 206 may be defined for 1, 2, or 4 serial lanes capable of running at a serial rate of 106.25 Gbps. For example, the interconnect links 206 may be designed in accordance with 100GBASE-KR1/CR1, 200GBASE-KR2/CR2, 400GBASE-KR4/CR4 standards.

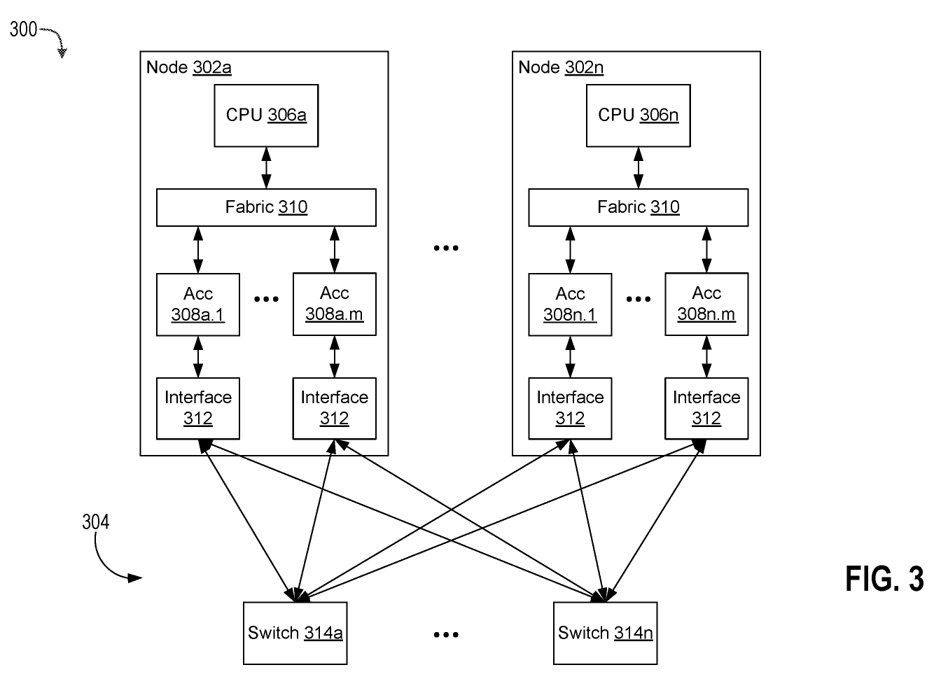

FIG. 3 illustrates a block diagram of an exemplary system 300, according to some embodiments. The system 300 may be configured to implement the techniques described herein, although others are possible. System 300 may be implemented with any combination of components and/or subsystems of system 100 and system 200.

System 300 may include one or more processing nodes 302 (shown as processing node 302a through processing node 302n). Each processing node 302 may be coupled to one or more other components of system 300 over an interconnect fabric 304. In some examples, each processing node 302 may be connected to one or more other processing nodes 302 over interconnect fabric 304 for data transmission and resource sharing purposes. In some examples, each processing nodes 302 may be selectively utilized to perform a processing or rendering operation either discretely or in parallel with one or more other processing nodes 302 in accordance with some orchestration scheme as determined by, for example, management controller 108 of FIG. 1.

In some examples, processing node 302 may include a host central processing unit (CPU) 306 (shown as CPU 306a through 306n), a plurality of accelerators 308, one or more of the components may be communicatively attached through host fabric 310 (or other connection circuitry). In some examples, the CPU 306, plurality of accelerators 308, and data fabric 310 may be coupled to (e.g., mounted on) a printed circuit board (e.g., motherboard).

The CPU 306 may be configured to process data and execute instructions of an operating system and/or instructions (e.g., program code) of one or more applications. In some examples, the functionality of the program code may be implemented by one or more of the CPU 306, one or more processor chiplets of a CPU 306, and/or one or more cores of a processor chiplet of a CPU 306. The data and instructions can be stored on a memory (not shown) coupled to CPU 306. The data and instructions can comprise computer-executable instructions implementing any suitable functionality.

In some examples, as part of executing a given software application, the CPU 306 launches rendering tasks to be performed on the plurality of accelerators 308. It should be appreciated that although FIG. 3 shows plurality of accelerators 308, the processing node 302 may include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc.), or a combination thereof.

In some examples, a host fabric 310 connects CPU 306 and plurality of accelerators 308, and other components within the processing node 302. The host fabric 310 may include any type of communication fabric, bus, and/or other control and interface logic for facilitating the communication of data between various components of the processing node 302. For example, the host fabric 310 may include data paths, switches, routers, and other logic used to communicate data among the various components. In some embodiments, the host fabric 310 may be bus-based, including shared bus configurations, crossbar configurations, and hierarchical buses with bridges. host fabric 310 may also be packet-based, and can be hierarchical with bridges, crossbar, point-to-point, or other interconnects.

In some examples, each processing node 302 may further include one or more interface devices 312. The one or more interface devices 312 may be used to communicatively connect the accelerators 308 of a processing node 302 to one or more other accelerators 308 of another processing node 302 for data transmission and resource sharing purposes over interconnect fabric 304. For example, one or more accelerators 308 (shown as accelerators 308a.1 through 308a.n) of processing node 302a may be connected to the one or more accelerators 308 (shown as accelerators 308n.1 through 308n.m) of processing node 302n over the interconnect fabric 304 for data transmission and resource sharing. For example, the one or more interface devices 312 may be network interface cards (“NICs”) for connecting the plurality of accelerators 308 of processing node 302 to the interconnect fabric 304 and one or more other components of the system 300. In some examples, interconnect fabric 304 may include a plurality of switches including at least switch 314a through 314n, and one or more of the plurality of accelerators 308 of processing node 302a may be communicatively connected to one or more of the plurality of accelerators 308 of processing node 302n through a plurality of switches 314a through switch 314n of interconnect fabric 304.

It should be appreciated that system 300 of FIG. 3 may further include one or more interface devices (e.g., NICs), and each CPU 306 may be connected to a respective interface device to enable front-end communication between the processing node 302 and one or more other components of system 300 over the interconnect fabric 304. For example, management controller 108 may send processing instructions to CPU 306 through the respective interface device.

It should be appreciated that FIG. 3 is intended neither to be a depiction of necessary components for a processing node or components thereof to operate in accordance with the principles described herein, nor a comprehensive depiction. The system 300 can include additional components, omit one or more of the described components, multiple instances of a component even if only one instance is shown in FIG. 3, and/or can be organized in other suitable manners.

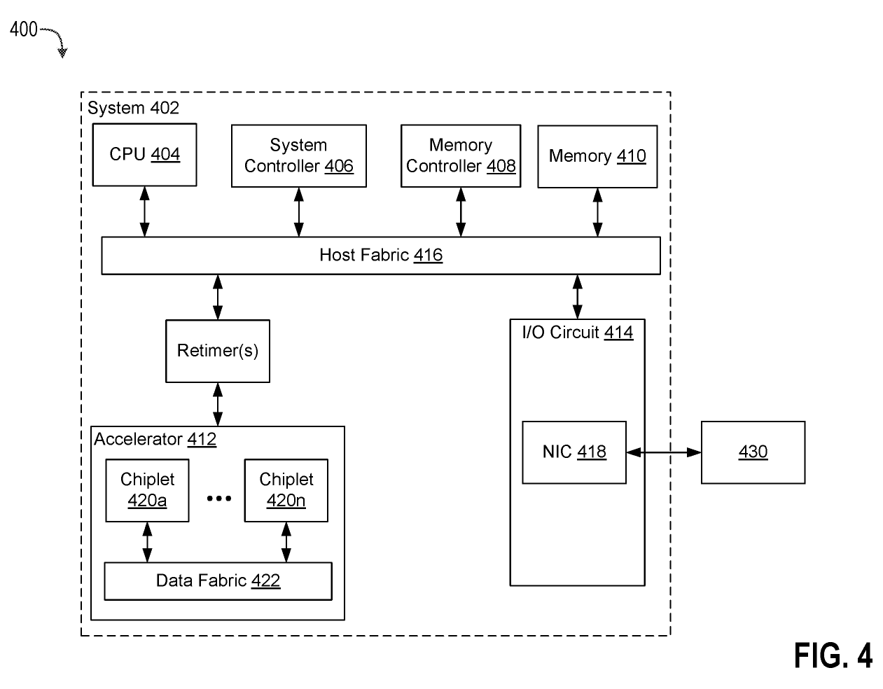

FIG. 4 is a block diagram of an exemplary system 400 configured to implement the techniques described herein, according to some embodiments. The system 400 may be configured to implement some techniques described herein, although other systems are possible. System 400 may be implemented with any combination of components and/or subsystems of system 100, system 200, and system 300.

The system 400 may be or otherwise be included within, for example, a desktop computer, a video game console, a server, a wireless access point or other networking element, a mobile computing device (e.g., laptop computers, tablets, smartphones, smartwatches, implantable health monitoring devices, wearable computers, personal digital assistants, etc.), or any other suitable computing system. It should be appreciated that FIG. 4 is intended neither to be a depiction of necessary components for a computer system or device to operate in accordance with the principles described herein, nor a comprehensive depiction. The system 400 can include additional components, omit one or more of the described components, multiple instances of a component even if only one instance is shown in FIG. 4), and/or can be organized in other suitable manners.

In some examples, the system 400 may be a processing node, which may include a central processing unit (CPU) 404, a system controller 406, and an accelerator 412, all communicatively attached through host fabric 416 (or other connection circuitry). In some examples, the CPU 404, system controller 406, accelerator 412, and host fabric 416 are coupled to (e.g., mounted on) a printed circuit board (e.g., motherboard).

The CPU 404 can include any combination of processing units, for example, one or more processor chiplets, each including one or more cores. In some examples, the processor chiplets (or other processing units) can communicate with each other via interconnects routed through or

on a package substrate. The CPU 404 is configured to process data and execute instructions of an operating system and/or instructions (e.g., program code) of one or more applications. In some examples, the functionality of the program code may be implemented by one or more of the CPU 404, one or more processor chiplets of a CPU 404, one or more cores of a processor chiplet, and/or the accelerator 412. The data and instructions can be stored on memory 410. The data and instructions stored on any of the computer-readable storage media (e.g., memory 410, registers, internal or external of the CPU 404, caches of the accelerator 412, etc.) can comprise computer-executable instructions implementing any suitable functionality.

The memory 410 can include a variety of computer-readable media for storing data, programs, instructions, etc. for use by the computer system 402. For example, memory 410 can include any combination of random access memory (RAM), read only memory (ROM); electronically erasable programmable read only memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the CPU 404 and/or the accelerator 412. The memory 410 can include computer-storage media in the form of volatile and/or nonvolatile memory. The memory 410 may be removable, non-removable, or any combination thereof. For example, memory 410 can include hardware devices such as hard drives, solid-state memory, optical-disc drives, and the like.

In some examples, as part of executing a given software application, the CPU 404 launches rendering tasks to be performed on the accelerator 412. The accelerator 412 can include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc.), or a combination thereof.

In some examples, a host fabric 416 connects CPU 404, memory 410 (directly of via one or more memory controllers 408), accelerator 412, I/O circuitry 414, and other components within the system 402. The host fabric 416, can include any type of communication fabric, bus, and/or other control and interface logic for facilitating the communication of data between various components of the computer system 402. For example, the host fabric 416 can include data paths, switches, routers, and other logic used to communicate data among the various

components. In some embodiments, the host fabric 416 can be bus-based, including shared bus configurations, crossbar configurations, and hierarchical buses with bridges. Host fabric 416 can also be packet-based, and can be hierarchical with bridges, crossbar, point-to-point, or other interconnects. The host fabric 416 is configured to route memory access requests and memory responses between any memory accessing components and/or the one or more memory controllers 408. The host fabric 416 can also include a system memory map (e.g., defined by BIOS) for determining destinations of memory accesses based on the system configuration.

In some examples, the computer system 402 includes a system controller 406, which may include one or more circuits. Each of the CPU 404, the memory 410 (directly of via one or more memory controllers 408), the accelerator 412, host fabric 416, and the I/O circuitry 414 can be bidirectionally connected to a system controller 406 (or power management controller), which forms a control fabric and is configured to provide memory access requests to host fabric 416. The system controller 406 can include a combination of hardware, software and firmware to assist in controlling storage, communications, timing, frequency, etc. within the computer system 402 and/or between parts of the computer system 402 and other systems (e.g., client devices).

For example, the system controller 406 manages power-up sequencing of the various processors and includes one or more clock sources (e.g., a phase locked loop (PLL)), to provide clock signals for each of the components of the computer system 402. The system controller 406 also manages power for the various processors and other functional blocks, and may receive measured power consumption values from CPU 404 and accelerator 412 to determine appropriate power states. The computer system 402 also implements various system monitoring and power saving functions, for example, thermal monitoring. The computer system 402 can assist in tracking mitigating action based on such monitoring. For example, if the computer system 402 becomes hot, then system controller 406 can reduce the frequency and voltage of CPU 404 and/or accelerator 412 or shut down the computer system 402 entirely. In some examples, the system controller 406 can control and/or trigger proactive and/or reactive mitigation actions to be taken based on monitored criteria. For example, the system controller 406 initiate proactive dynamic workload control and/or reactive “big hammer” actions such as drastic clock frequency reduction.

The one or more memory controllers 408 are configured to control the flow of data to and from the memory 410. For example, the memory controller 408 can handle the reading and writing of data to and from the memory 410, schedule access to the memory 410 to optimize bandwidth and latency, detect and correct errors in data stored in memory, translate logical addresses into physical addresses, adjust the use of available memory bandwidth to maximize performance, among other tasks.

In some examples, the I/O circuitry 414 may be configured to physically connect and communicate with one or more other components. In some examples, the I/O circuitry 414 may include a network interface card (NIC) 418 to connect the computer system 402 to an interconnect fabric 430 of a network system such as, for example and without limitation, system 100 of FIG. 1. In some examples, the NIC 418 may be a standalone card separate from the I/O circuitry 414.

In some examples, the I/O circuitry 414 may be configured to physically connect to peripheral devices and control the flow of data to and from the memory 410 and/or storage. Some non-limiting examples of an input device can include a mouse, keyboard, scanner, video game controller, microphone, webcam, etc. Some non-limiting examples of an output device can include a display, printer, speakers, headphones, earbuds, etc. The I/O circuitry 414 can include any suitable type of peripheral connector(s), including, without limitation, universal serial bus (e.g., USB-A, USB-B, USB-C, USB-3.0, etc.), Ethernet, DisplayPort, high-definition multimedia interface (HDMI), peripheral component interconnect (PCI), peripheral component interconnect eXtended (PCI-X), peripheral component interconnect express (PCIe), accelerated graphics port (AGP), etc. In some examples, portions of the I/O circuitry 414 can be integrated into a motherboard and/or motherboard chipset (e.g., I/O circuitry 414) of the computer system 402.

As described above, computer system 402 may have one or more components and peripherals, including input and output devices. These devices may be used, among other things, to present a user interface. Examples of output devices that can be used to provide a user interface include display screens for visual presentation.

In some examples, the accelerator 412 may include any combination of processing units, for example, one or more processor chiplets, each including one or more cores. In some examples, the processor chiplets (or other processing units) can communicate with each other via a data fabric 422 comprising interconnects internally routed between each of the chiplets 420a through 420n of accelerator 412. The interconnects may in some embodiments be routed through or on a package substrate to connect the chiplets 420a through 420n. The accelerator 412 may be configured to process data and execute instructions of CPU 404 and/or instructions (e.g., program code) of one or more applications. In some examples, the functionality of the program code may be implemented by one or more of the accelerators 412, one or more processor chiplets of accelerator 412, one or more cores of a processor chiplet, and/or the CPU 404. The data and instructions may be stored on memory 410 and/or memory (not shown). The data and instructions stored on any of the computer-readable storage media (e.g., memory 410, registers, internal or external of the CPU 404, caches of the processing unit 420, etc.) can comprise computer-executable instructions implementing any suitable functionality.

The flit alignment techniques described herein may be implemented in systems including system 100 of FIG. 1, system 200 of FIG. 2, system 300 of FIG. 3, system 400 of FIG. 4, among other systems or computing systems. Referring again to FIG. 3, in some examples, node 302 may have a computer architecture embodied as any combination of hardware, software, or firmware suitable to implement the flit alignment techniques described herein at an interface connecting two or more components. The interface may, in some embodiments, be utilized to convert flits to 64B/66B blocks, the first n number of 64B/66B blocks being for the flit alignment based on the length of the alignment markers in the flits, which depend on the PCS and data rate. For example, the flit alignment techniques may be implemented at an interface for data transmission between the accelerators 308 within a respective node 302 or between accelerators 308 of different nodes 302. Referring again to FIG. 4, in some examples, accelerator 412 may have a computer architecture embodied as any combination of hardware, software, or firmware suitable to implement the flit alignment techniques described herein at an interface connecting two or more chiplets 420. The interface may, in some embodiments, be implemented in circuits to optimize latency and replay bandwidth in some applications that may not be able to accommodate a sideband such as between chiplets 420 located on a system on chip (SOC) within accelerator 412. The interface can be utilized to align flits to codewords in accordance with the flit alignment techniques described herein without necessitating the sideband, thereby being capable of being utilized in system architectures that may not easily accommodate sidebands in the circuitry.

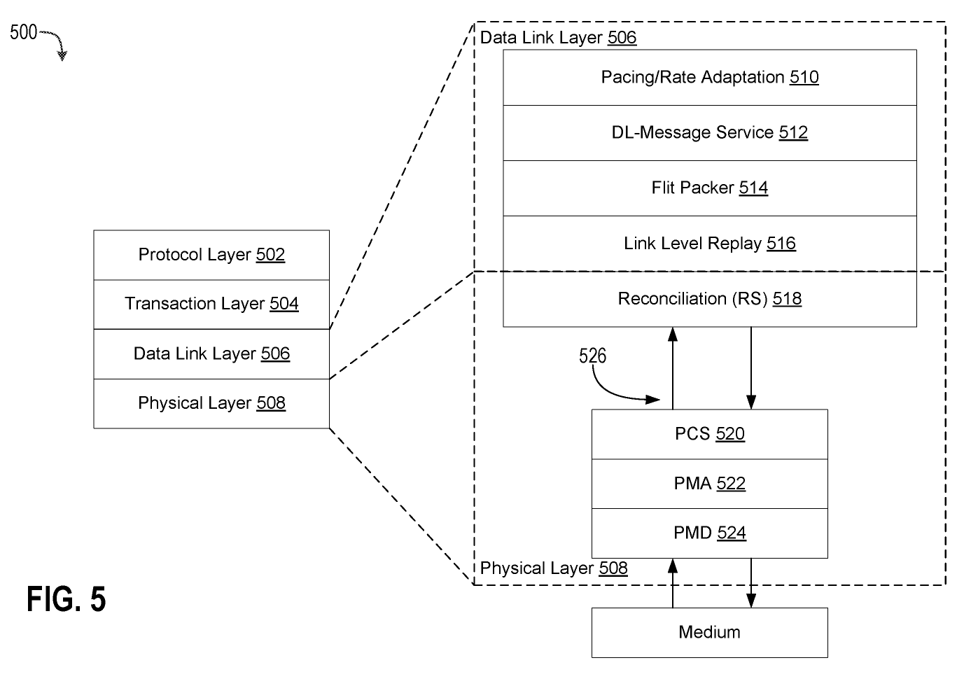

FIG. 5 illustrates an example diagram of a portion of an exemplary communication system 500 for aligning the flits to codewords, according to some embodiments. The communication system 500 may be configured to implement some techniques described herein, although other systems are possible. Communication system 500 may be implemented with any combination of components and/or subsystems of system 100, system 200, system 300, and system 400.

The communication system 500 described herein may include a system architecture having a communication protocol designed to align flits to codewords by, for example, overwriting existing alignment markers for data transmission in the transmit (Tx) direction or to indicate when the flit contains alignment markers in the receive (Rx) direction. The system architecture may include a layered communication protocol, each layer including one or more sub-layers designed to implement the flit alignment techniques described herein such that the flit boundary aligns with the start of the existing alignment markers to provide robust and efficient data exchange between link partners while improving latency and replay bandwidth.

In some examples, system architecture of communication system 500 may include a protocol layer (UPL) 502, a transaction layer (TL) 504, a data link layer (DL) 506, and a physical layer (PHYL) 508. Each of these layers may be responsible for specific functions that collectively enable seamless communication between link partners. The communication system 500 may carry messages between a sender and receiver in accordance with the layers of communication system 500. In addition, the communication system 500 may be a symmetrical protocol with the same set of messages and channels supported in both transmit and receive paths. During communication, these messages may traverse through multiple functional layers of the communication system 500 in the journey between originator and transmitter (e.g., sender and receiver).

The UPL 502 may define a logical signaling interface and a protocol by which devices can exchange data and control information through a set of Request and Response messages. The UPL 502 of communication system 500 may define the protocol and may expect implementations that follow this protocol will be compatible with the interconnect fabric such as, for example, network fabric 112. The communication system 500 may include built-in flexibility to allow vendors to create custom protocol messages for communication between processing units without any modification to the interconnect switches.

The TL 504 may be coupled to two PL interfaces (not shown), one interface may be communicatively coupled to an originator device via UPL 502 and the other interface may be communicatively coupled to a completer device via UPL 502 (not shown). The TL 504 may drive a 64-byte Outbound Transmit (Tx) Flit to the DL 506 and may receive from the DL 506 a 64-byte Inbound Receive (Rx) Flit. The channels driven into the TL 504 from both interfaces may be packaged into 64-byte Outbound Transmit (Tx) Flits, which may be transmitted to the DL 506. Similarly, the Receive (Rx) 64-byte TL Flit from the DL 506 may be unpacked into Request, Read Response/Data, Orig Data, and Write Response channels for the two interfaces coupled to the TL 504, which may be transmitted to one of the originator or completer devices.

The DL 506 may receive TL flits (e.g., outbound Tx flits) from the TL 504 and may package these TL flits into outbound DL flits in the transmit direction and may send them to the PHYL 508. Similarly, in the receive direction the DL 506 may receive DL flits from the PHYL 508 and may unpack them into TL flits (e.g., inbound Rx flits) and then may send them to the TL 504. The DL 506 may provide a control message service used for coordinating changes to the link, i.e., online/offline, and other features. In some examples, the DL 506 may provide a mechanism for packing the TL flits into DL flits in the transmit direction and unpacking the TL flits from the DL flits in the receive direction by alignment marker overwrite in accordance with the techniques described herein. In some examples, in response to detecting a start flit sequence in the transmit direction, the alignment marker overwrite may replace the first five 256B/257B blocks with the alignment marker. In some examples, in the receive direction, the flit code sequence that is expected to contain the alignment markers is converted to an AM flit code sequence.

Referring to FIG. 5, the DL 506 may pack and unpack the TL flits at one or more sub-layers, which may include a pacing/rate adaptation sublayer 510, DL-message service sublayer 512, flit packer sublayer 514, and link level replay sublayer 516. In some examples, the packing of TL flits into DL flits and unpacking of TL flits from DL flits may be implemented at the flit packer sublayer 514, which may be used to pack the TL flits into the DL flits, as will be further described herein.

The PHYL 508 may include one or more sub-layers including a reconciliation sublayer (RS) 518, a physical coding sublayer (PCS) 520, a physical medium attachment (PMA) 522, and a physical medium dependent (PMD) 524. The RS 518 may in some examples adapt the flit format of DL 506 into a stream of blocks. Each data direction may be independent of the other. The RS 518 may generate a continuous stream of data or control blocks on the transmit path and may expect a continuous stream of data or control blocks on the receive path. Transmitting a continuous stream of data blocks may be defined as transmitting blocks back-to-back, and the DL flits may not include start or terminate blocks to demark the beginning and end of DL Flits.

The RS 518 may receive flits from DL 506 and may transmit a flit code sequence based on the received flit. A flit code sequence may in some examples include 64B/66B data blocks or control blocks. Data flit code sequences may in some examples originate and terminate at the DL 506. Control flit code sequences may, in some examples, originate and terminate at the RS 518. A data flit code sequence may, in some examples, consist essentially of 64B/66B data blocks. A control flit code sequence may, in some examples, consist essentially of 64B/66B control blocks.

The flit code sequence transmitted between RS 518 and PCS 520 may be start flit code sequences or alignment marker (AM) flit code sequences. Start flit code sequences may include idle start flit code sequences and fault start flit code sequences and may be transmitted RS 518 to PCS 520 to indicate the start of a flit code sequence and to indicate to the PCS 520 when to overwrite an alignment marker. The flit that is transmitted by PCS 520 may, in some embodiments, have the alignment markers in the first four to sixteen 256B/256B blocks, as a function of PCS 520.

AM flit code sequences may be used in the Rx direction PCS 520 to RS 518 and may be used by the RS 518 to determine receive flit alignment. The blocks may, in some examples, be 64B/66B blocks, and the flit code sequence may in some examples include 80 consecutive 64B/66B blocks. From the DL 506 perspective a data flit may include 20 consecutive 256B/257B blocks (640 bytes), which may be logically serialized/deserialized by the RS into the 80 consecutive 64B/66B blocks.

The RS 518 may also, in some examples, participate in link fault detection and may report link faults using the control flit code sequences by monitoring the receive path for status reports that may indicate an unreliable link and generating status reports on the transmit path to report detected link faults to the peer on the remote end of the connecting link.

The RS 518 may, in some examples, provide the DL flit to codeword alignment. Each flit that the DL 506 generates may fit into one RS(544,514) codeword. The RS 518 may, in some examples, indicate to PCS 520 when to overwrite alignment markers in the Tx direction and may, in some examples, indicate when alignment markers are received in the Rx direction. The RS 518 may also, in some examples, indicate to DL 506 the start of receive flits.

Flits from DL 506 may include no operation (NOP) flits or payload flits. In some embodiments, some flits received by the RS 518 from the DL 506 may be NOP flits, which do not include payload data. Instead, some NOP flits may be control flits that may be utilized for operations including link fault signaling, to indicate when to overwrite alignment markers in the Tx direction, to indicate when a flit contains alignment markers in the Rx direction, and for idle transmission or reception, or any combination thereof. Idle transmission may be utilized for rate matching or in response to receiving remote faults. In some embodiments a flit may carry alignment markers and the remainder of the flit may be idle filled.

RS 518 may receive data flits from DL 506 in the Tx direction and RS 518 may transmit start flit code sequences to PCS 520 to indicate the start of the flit code sequence and to indicate to PCS 520 when to overwrite an alignment marker. The start flit code sequence may include idle start flit code sequences and fault start flit code sequences. In some embodiments, each idle start flit code sequence may include 80 consecutive 64B/66B control blocks with the same content as an idle flit code sequence except the first eight transmitted 64B/66B control block has a block type of 0x78, and each data byte is set to 0x00. RS 518 may transmit the idle start flit code sequence when the RS 518 determines that it is time to send an alignment marker, and the RS 518 determines that it should not be sending fault flits, i.e. it is sending data flits. In some embodiments, each idle flit code sequence may include 80 consecutive 64B/66B control blocks with a block type of 0x1E, and each control code (in the 64B/66B control block) may indicate idle (/I/). RS 518 may transmit the idle flit code sequence when receiving remote fault indication, when the DL 506 is in DL 506 idle link state, and when the DL 506 is in DL 506 up or DL 506 NOP states. In some embodiments, each fault start flit code sequence may include 80 consecutive 64B/66B control blocks with the same content as a fault flit code sequence except the first eight transmitted 64B/66B control block has a block type of 0x78, and each data byte is set to 0x00. RS 518 may transmit the fault start flit code sequence when the RS 518 determines that it is time to send an alignment marker, and the RS 518 also determines to send fault flits based on a fault state detection. In some embodiments, each fault flit code sequence may include 80 consecutive 64B/66B control blocks with a block type of 0x4B, indicating a sequence ordered set. There may be two types of fault Flit Code Sequences, local and remote, in some embodiments. RS 518 may transmit the fault flit code sequences during certain fault states.

In the Rx direction, the PCS 520 may utilize alignment market (AM) flit code sequences to enable RS 518 to determine receive flit alignment. For example, an AM flit code sequence may have 80 consecutive 64B/66B control blocks, the first n transmitted 64B/66B control blocks may have a block type of 0x78, and all data bytes may be set to 0xFF. Additionally, the remaining 64B/66B blocks of the AM flit code sequence may have a block type of 0x1E, and every control block may be /I/ in the 64B/66B block. It is to be appreciated that the value of n may be a function of the length of the alignment markers, which may be PCS and data rate dependent. In some examples, at 100G, the first 5*4 (20) transmitted 64B/66B blocks may have a block type of 0x78 and the data bytes may be set to 0xFF, and the remaining 64B/66B blocks may have a block type of 0x1E and every control code (in the 64B/66B block) may be idle (/I/). In some examples, at 200G, the first 4*4 (16) transmitted 64B/66B blocks may have a block type of 0x78 and the data bytes may be set to 0xFF, and the remaining 64B/66B blocks may have a block type of 0x1E and every control code (in the 64B/66B block) may be idle (/I/). In some examples, at 400G, the first 8*4 (32) transmitted 64B/66B blocks may have a block type of 0x78 and the data bytes may be set to 0xFF, and the remaining 64B/66B blocks may have a block type of 0x1E and every control code (in the 64B/66B block) may be idle (/I/). In some examples, at 800G, the first 16*4 (64) transmitted 64B/66B blocks may have a block type of 0x78 and the data bytes may be set to 0xFF, and the remaining 64B/66B blocks may have a block type of 0x1E and every control code (in the 64B/66B block) may be idle (/I/).

The RS 518 may, in some embodiments, send the AM flit code sequences responsive to the PCS 520 having achieved alignment lock. That is, in the Rx direction, the RS 518 may send the AM flit code sequences when the PCS 520 receives or expects to receive a codeword containing the alignment marker. Accordingly, in the Rx direction, the AM flit code sequence sent by the RS 518 may replace the flit(s) containing the alignment marker(s). In some embodiments, bit errors may impact alignment marker detection, which may occur prior to forward error correction (FEC) decode. In this regard, the PCS 520 may send the AM flit code sequence to replace the received flit containing the alignment marker before FEC decode is performed because the FEC decode may be based on alignment.

In the Tx direction, the start flit code sequences may be sent at an interval suitable for PCS 520 to transmit alignment markers as a function of data rate. In some examples, at 100G, RS 518 may transmit the start flit code sequences every 4,096 flits. In some examples, at 200G, RS 518 may transmit the start flit code sequences every 4,096 flits. In some examples, at 400G, RS 518 may transmit the start flit code sequences every 8,192 flits. In some examples, at 800G, RS 518 may transmit the start flit code sequences every 16,384 flits. In this regard, the start flit code sequences from the RS 518 in the Tx direction provide flit synchronization to PCS 520, so that each flit is packed into the codeword. PCS 520 may overwrite the first k blocks with alignment markers as a function of data rate. In some examples, at 100G, PCS 520 may overwrite the first 5, 257-bit blocks. In some examples, at 200G, PCS 520 may overwrite the first 4, 257-bit blocks. In some examples, at 400G, PCS 520 may overwrite the first 8, 257-bit blocks. In some examples, at 800G, PCS 520 may overwrite the first 16, 257-bit blocks. In the Rx direction, the alignment markers provide lane deskew and reorder to PCS 520. In addition, the start flit code sequence may be converted to an AM Flit Code Sequence by PCS 520, which provides flit synchronization for RS 518.

The RS 518 may also, in some examples, indicate to DL 506 if the received flit is a control flit or a data flit, and RS 518 may pass the data flits onward to the DL 506. In addition, the RS 518 may, in some examples, use the receiving control flits for link up, link down determination in the DL Link State Machine.

The PHYL 508 may support one or more rates of serial communication over an interconnect link between two link partners. In some examples, the PHYL 508 may support 200G serial transmission including, for example and without limitation, 200GBASE-KR1/CR1, 400GBASE-KR2/CR2, and 800GBASEKR4/ CR4. In some examples, the PHYL 508 may also support 100G serial transmission including, for example and without limitation, 100 GBASE-KR1/CR1, 200 GBASE-KR2/CR2, 400 GBASE-KR4/CR4. To reduce latency at the 200G serial rates, 1-way and 2- way codeword interleave modes may be supported, in addition to 4-way interleave.

To improve latency each DL Flit may be packed uniquely into a single 640-Byte codeword. The additional 40 bytes of the codeword (e.g., 680-Byte) may be for FEC overhead and 256B/257B line coding. DL Flit to codeword alignment may be achieved without implementing changes to a PCS, regarding alignment marker insertion and removal. That is, in some examples, the alignment markers on the wire(s) may be unchanged from IEEE 802.3 definition. Instead, only the mechanism for how the alignment markers may be inserted and removed may be modified to enable the RS 518 to decide when to start the sequences for sending the alignment markers.

In some examples, retimers may also be compatible provided they use the recovered clock for forwarding the data. This is the most common mechanism. Adding or removing idle codes may require FEC decode and encode and may incur a large latency penalty. In addition, this may break the DL Flit to codeword association required for seamless and efficient communication over the interconnect link by communication system 500. Auto negotiation and link training may also be unchanged from a communication standard.

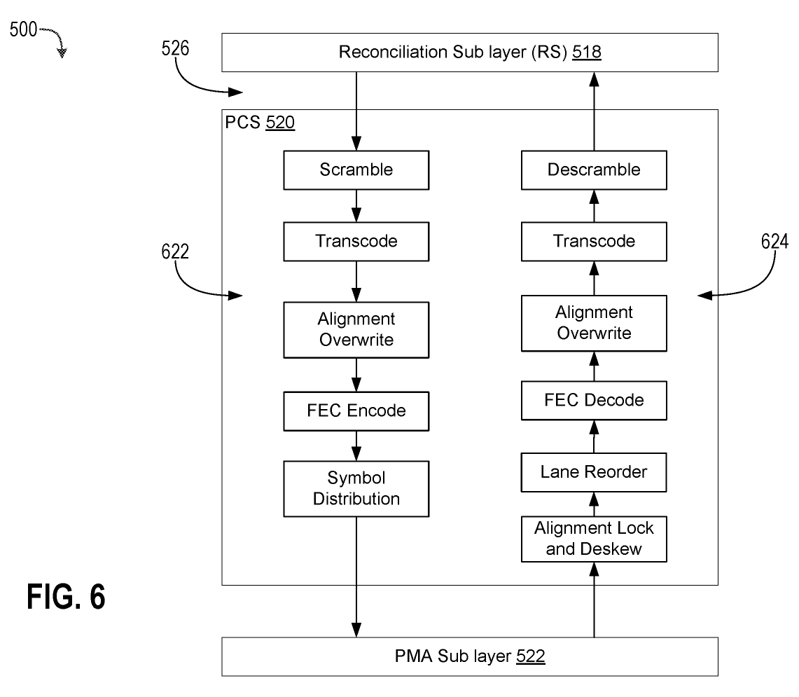

FIG. 6 illustrates an example diagram of a portion of communication system 500 for aligning the flits to codewords, according to some embodiments. The communication system 500 may be configured to implement some techniques described herein, although other systems are possible. Communication system 500 may be implemented with any combination of components and/or subsystems of system 100, system 200, system 300, and system 400.

In order to maintain flit boundary to codeword alignment between DL 506 and PCS 520 (FIG. 5) during data communication between link partners, a flit may be designated for the purpose of transmitting the alignment markers, which can indicate when to overwrite PCS 520 (FIG. 5) alignment markers in Tx direction 622 or can indicate when a flit contains alignment markers in Rx direction 624. The flit to codeword alignment may improve latency and replay bandwidth in the data communications.

In Tx direction 622, start flit code sequences may be transmitted from RS 518 to PCS 520 to indicate the start of the alignment markers and to indicate when to overwrite the alignment markers. RS 518 may send the start flit code sequences at an interval for PCS 520 to transmit alignment markers as a function of data rate in accordance with the techniques described herein. In Tx direction 622, the PCS 520 may overwrite the first several 256B/257B blocks (same step as alignment insertion) of the flit transmitted by PCS 520 with the alignment markers based on the start flit code sequence and in accordance with the techniques described herein such that each flit is packed into a codeword. In some embodiments, PCS 520 may pack each flit within a RS codeword boundary based on the start flit code sequence. In some embodiments, based on the start flit code sequence, the PCS 520 may overwrite the first four to sixteen 256B/257B blocks as a function of the PCS 520 for data communication over the interconnect. In some embodiments, PCS 520 may overwrite the first k 256B/257B blocks with alignment markers as a function of data rate in accordance with the techniques described herein. In some examples, the PCS 520 may overwrite the first 5 256B/257B blocks at 100G. In some examples, the PCS 520 may overwrite the first 4 256B/257B blocks at 200G. In some examples, the PCS 520 may overwrite the first 8 256B/257B blocks at 400G. In some examples, the PCS 520 may overwrite the first 16 256B/257B blocks at 800G.

In Rx direction 624, alignment marker flit code sequences may be transmitted from the PCS 520 to RS 518 for RS 518 to determine receive flit alignment. The alignment markers provide the ability for lane deskew and reorder to PCS 520 for communications across one or more channels (e.g., lanes). Additionally, the start flit code sequence may be converted to an AM flit code sequence by PCS 520, which may provide receive flit synchronization for RS 518. AM flit code sequences may include 80 consecutive 64B/66B control blocks. The first n transmitted 64B/66B control blocks may have a block type of 0x78, and the data bytes may be set to 0xFF. The remaining 64B/66B blocks may have a block type of 0x1E, and each control code (in the 64B/66B control block) may indicate idle (/I/). In some embodiments, the value of n may be a function of the length of the alignment markers, which may be PCS 520 and data rate dependent in accordance with the techniques described herein. The AM flit code sequences may be sent when PCS 520 achieves alignment lock, which may correspond to when PCS 520 is expected to or does receive a codeword containing the alignment marker. The AM flit may replace the received flit containing the alignment marker, which may be used for flit alignment by the RS 518. Bit errors may, in some examples, impact alignment marker detection, which may occur prior to FEC decode. The AM flit may replace the received flit containing the alignment marker.

In the RX direction, RS 518 may determine the alignment of each group of 80 * 64B/66B blocks that are destined for DL 506. The receipt of the first 64B/66B block from the AM flit indicates the nominal timing for each group of 80 * 64B/66B blocks. Due to rate matching and idle insertion or deletion this timing may need to be adjusted. In some embodiments, if idles are inserted between data flits in PCS 520 for rate matching, then these idles may be consumed by RS 518, the sync header may indicate 0b10 for control codes. In addition, idles may also be found in the groups of the 80 * 64B/66B blocks corresponding to idle flit code sequence, idle start flit code sequence, or AM flit code sequence. These idles may also be consumed by RS 518. In some embodiments, if idles are removed from idle flit code sequence, idle start flit code sequence, or AM flit code sequence, the data flit may occur earlier than the nominal 80 * 64B/66B block. In some embodiments, when the RS 518 receives a sync header indicating data and the previous sync header indicating control, this indicates the start of a data flit and all control blocks may be sent to DL 506. For example, when the RS 518 receives a sync header of 0b01 indicating data and the previous sync header was 0b10 indicating control, this indicates the start of a data flit and all 80 * 64B/66B blocks may be sent to DL 506. In some embodiments, when RS 518 receives a sync header indicating data and a data flit was just received and sent to DL 506, then the next 80 * 64B/66B blocks may be sent to DL 506. For example, back-to-back data flits may be indicated responsive to RS 518 receiving a sync header of 0b01 indicating data and a data flit was just received and sent to DL 506.

To maintain data flit to codeword alignment, RS 518 may designate an entire flit for the purpose of transmitting the alignment markers. PCS 520 does not insert alignment markers which would impact flit to codeword alignment. Instead, the alignment markers are overwritten into the designated start flit code sequences. In Tx direction 622, PCS 520 overwrites the first several 256B/257B blocks (same step as alignment insertion) of the start flit code sequence with the alignment markers as a function of data rate. The PCS 520 uses the start flit code sequence to align groups of 80 * 64B/66B blocks into one codeword. In Rx direction 624, the flit code sequences including the alignment markers may be converted to AM flit code sequences in PCS 520 and used for flit alignment by RS 518. Flit code sequences may be sent when the PCS 520 has achieved alignment, and the AM flit code sequence may replace the received flit code sequence according to the alignment lock determined in the PCS 520. It should be appreciated that the alignment markers on the wire may be identical to conventional PCS clauses and may provide the same or similar lane deskew functionality and DL Flit alignment on receive. That is, the interface 526 between RS 518 and PCS 520 may be implemented to provide the DL Flit to codeword alignment in accordance with the techniques described herein.

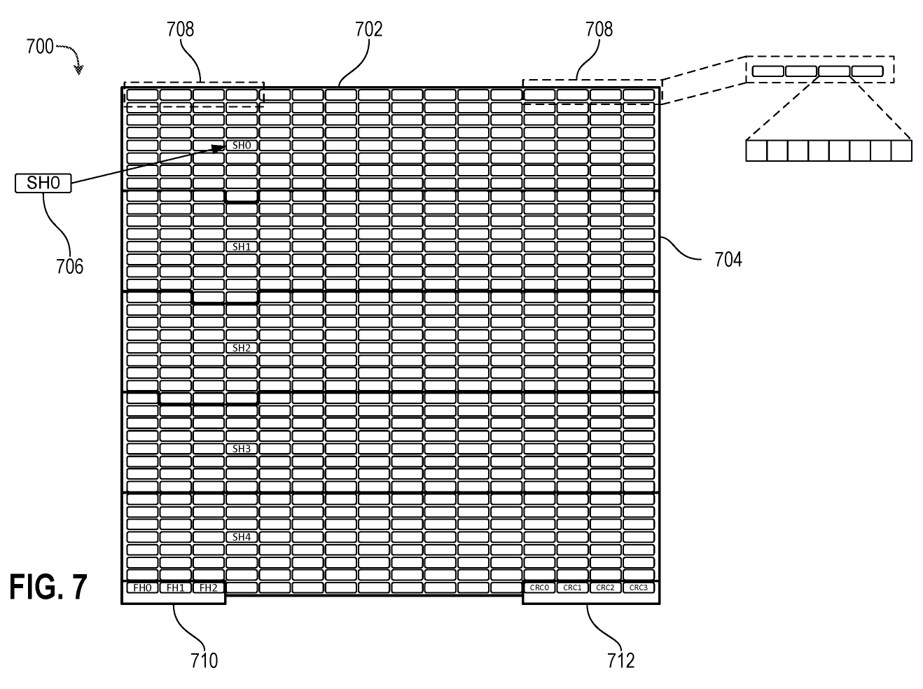

FIG. 7 illustrates an exemplary datagram 700, according to some embodiments. The datagram 700 may be implemented in accordance with some techniques described herein, although other control data packets are possible. Datagram 700 may in some examples be a DL flit, which may be implemented with any combination of components and/or subsystems of system 100, system 200, system 300, system 400, and communication system 500.

The datagram 700 may be a DL flit 702. The DL flit 702 may include d number of data segments 704. For example, datagram 700 may include five data segments 704. Each data segment 704 of the d number of data segments 704 may include a segment header 706 (shown as SH0, SH1, SH2, SH3, and SH4) and m number of sectors 708, with each sector 708 having a predefined number of bytes. For example, each sector may include 4-bytes (or 32-bits). Each segment header 706 may describe the data that starts in the data segment 704. The m number of sectors 708 may be for packing a data payload. In some examples, up to two TL flits may be packed into each segment 704 as the data payload. In some examples, up to two 64-byte TL flits may be packed into each segment 704, and the corresponding segment header 706 may be encoded so as indicate the presence of each respective TL flit in the segment 704.

The DL flit 702 may also include a flit header 710 and a CRC 712 that may be appended to the DL flit 702 such that one or more of the data segments 704 may include less than m number of sectors 708 for packing the data payload. The flit header 710 may indicate the type of data and sequence number to aid in link level replay, and other information. The CRC 712 may be a calculated value characterizing the contents of the DL flit 702.

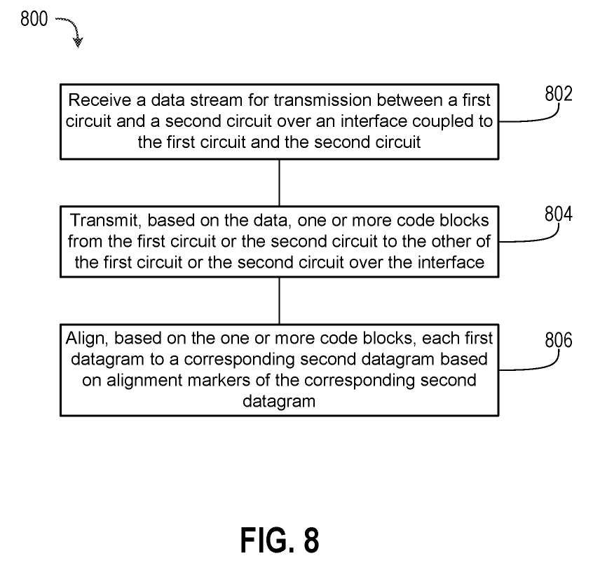

FIG. 8 is a flow diagram of a method 800, according to some embodiments. Method 800 may be implemented in accordance with some techniques described herein, although other methods are possible. Method 800 may be implemented with any combination of components and/or subsystems of system 100, system 200, system 300, system 400, and communication system 500. Method 800 may be implemented using datagram 700, although other datagrams are possible. Method 800 may be for data transmission between link partners over an interconnect link. The link partners may be, for example, computing systems, computing devices, servers, accelerator nodes, processors, chiplets, or any combination thereof, among other components. The interconnect link may be part of a fabric, which may be Ethernet cable of various data rates including, for example and without limitation, 100G, 200G, 400G, and 800G.

At 802, the method 800 may include receiving a data stream for transmission between a first circuit and a second circuit over an interface coupled to the first circuit and the second circuit, the first circuit comprising first datagrams and the second circuit comprising second datagrams. In some embodiments, the first datagrams may be data link flow control units and the second datagrams may be codewords. The first circuit can correspond to RS 518, the second circuit can correspond to PCS 520, and the interface can correspond to interface 526 as shown in FIG. 5.

At 804, the method 800 may include transmitting, based on the data, one or more code blocks from the first circuit or the second circuit to the other of the first circuit or the second circuit over the interface.

At 806, the method 800 may include aligning, based on the one or more code blocks, each first datagram to a corresponding second datagram based on alignment markers of the corresponding second datagram.

In some embodiments, the aligning of the datagrams based on alignment markers may include overwriting, in a transmit direction, an alignment marker of the corresponding second datagram by the second circuit based on the one or more code blocks. In some embodiments, in the transmit direction, the second circuit may overwrite the alignment marker of the corresponding second datagram based on a set of code blocks transmitted from the first circuit or the second circuit to the other of the first circuit or the second circuit over the interface. In some embodiments, in the transmit direction, the second circuit may overwrite the alignment marker of the corresponding second datagram based on one or more first code blocks. The first code blocks may be start flit code sequences as described with regards to FIG. 5.

In some embodiments, the first code blocks may be start flit code sequences. In some embodiments, in the transmit direction, the first circuit transmits the one or more code blocks at an interval for the second circuit to transmit alignment markers as a function of data rate of the interconnect. In some embodiments, the second circuit overwrites a first n blocks of the corresponding second datagram as a function of the data rate of the interconnect such that each first datagram is packed into the corresponding second datagram.

In some embodiments, the aligning of the datagrams based on alignment markers may include converting, in a receive direction, the corresponding second datagram including the alignment marker with the one or more code blocks by the second circuit. In some embodiments, the first circuit may align each first datagram to the converted second datagram based on the one or more code blocks. In some embodiments, in the receive direction, the second circuit converts the corresponding second datagram including the alignment marker with one or more second code blocks. In some embodiments, the second code blocks are AM flit code sequences. The second code blocks may correspond to the AM flit control sequences as described with regards to FIG. 5.

In some embodiments, the second datagram includes a variable length. In some embodiments, the alignment markers of the second datagram are originally aligned in accordance with a pre-existing communication standard. In some embodiments, the pre-existing communication standard is a PCS clause associated with Ethernet codewords. In some embodiments, the alignment markers of the second datagram are realigned in accordance with a boundary of the first datagram.

In some embodiments, an apparatus for data communication between link partners over an interconnect link includes at least one circuit including a first circuit corresponding to a data link layer, and a second circuit corresponding to a physical layer, the second circuit including a first sublayer, a second sublayer located between the first sublayer and the interconnect link, and an interface communicatively coupling the first sublayer to the second sublayer for transmission of code blocks between the first and second sublayers during data communications between the link partners, the code blocks configured to align a first datagrams of the first sublayer to a second datagrams of the second sublayer based on alignment markers of the second datagrams.

In some embodiments, in a transmit direction, the first sublayer sends a first code blocks to the second sublayer to indicate when to overwrite the alignment markers of the second datagrams.

In some embodiments, based on the first code blocks from the first sublayer, the second sublayer transmits a modified second datagrams including alignment markers in the first four to sixteen code blocks according to a function of a clause of the second sublayer.

In some embodiments, the first code blocks include start flit code sequences.

In some embodiments, in a receive direction, the second sublayer sends a second code blocks to indicate when the first datagrams include alignment markers.

In some embodiments, the second code blocks indicate the second sublayer is expected to, or receives, second datagrams including the alignment markers, and the second sublayer replaces a portion of the second datagrams including the alignment markers with the second code blocks.

In some embodiments, the second code blocks include alignment marker flit code sequences.

In some embodiments, the second sublayer replaces a portion of the second datagrams including the alignment markers with the second code blocks prior to forward error correction decode.

In some embodiments, the second code blocks are configured to align the first datagrams to a start of the second datagrams based on the alignment markers of the second datagrams to improve latency and replay bandwidth.

In some embodiments, a system includes a plurality of processors including a first processor in communication with at least one second processor over an interconnect fabric, and at least one circuit including a first circuit corresponding to a data link layer, and a second circuit corresponding to a physical layer, the second circuit including a first sublayer circuit, a second sublayer circuit located between the first sublayer circuit and the interconnect fabric, and an interface communicatively coupling the first sublayer circuit to the second sublayer circuit for transmission of code blocks between the first and second sublayer circuits during data communications between the first processor and the at least one second processor, the code blocks configured to align a first datagrams of the first sublayer circuit to a second datagrams of the second sublayer circuit based on alignment markers of the second datagrams.

In some embodiments, in a transmit direction, the first sublayer circuit sends a first code blocks to the second sublayer circuit to indicate when to overwrite the alignment markers of the second datagrams, and in a receive direction, the second sublayer circuit sends a second code blocks to indicate when the first datagrams include alignment markers.

In some embodiments, based on the first code blocks from the first sublayer circuit, the second sublayer circuit transmits a modified second datagrams including alignment markers in the first four to sixteen code blocks according to a function of the second sublayer circuit. In some embodiments, the first code blocks include start flit code sequences.

In some embodiments, the second code blocks indicate the second sublayer circuit is expected to, or receives, second datagrams including the alignment markers. In some embodiments, the second sublayer circuit replaces a portion of the second datagrams including the alignment markers with the second code blocks. In some embodiments, the second code blocks include alignment marker flit code sequences.

In some embodiments, the second sublayer circuit replaces a portion of the second datagrams including the alignment markers with the second code blocks prior to forward error correction decode.

In some embodiments, the second code blocks are configured to align the first datagrams to a start of the second datagrams based on the alignment markers of the second datagrams to improve latency and replay bandwidth.

In some embodiments, a method for data transmission between link partners over an interconnect link, the method includes receiving a data stream for transmission between a first circuit and a second circuit over an interface coupled to the first circuit and the second circuit, the first circuit including a first datagrams and the second circuit including a second datagrams, transmitting, based on the data, one or more code blocks from the first circuit or the second circuit to the other of the first circuit or the second circuit over the interface, and aligning, based on the one or more code blocks, each first datagram to a corresponding second datagram based on alignment markers of the corresponding second datagram. In some embodiments, the aligning includes at least one of overwriting, in a transmit direction, an alignment marker of the corresponding second datagram by the second circuit based on the one or more code blocks, or converting, in a receive direction, the corresponding second datagram including the alignment marker with the one or more code blocks by the second circuit. In some embodiments, the first circuit aligns each first datagram to the converted second datagram based on the one or more code blocks. In some embodiments, the first datagrams are data link flow control units and the second datagrams are codewords.

In some embodiments, in the transmit direction, the second circuit overwrites the alignment marker of the corresponding second datagram based on one or more first code blocks. In some embodiments, the first code blocks are start flit code sequences.

In some embodiments, in the receive direction, the second circuit converts the corresponding second datagram including the alignment marker with one or more second code blocks. In some embodiments, the second code blocks are AM flit code sequences.

In some embodiments, in the transmit direction, the first circuit transmits the one or more code blocks at an interval for the second circuit to transmit alignment markers as a function of data rate of the interconnect. In some embodiments, the second circuit overwrites a first n blocks of the corresponding second datagram as a function of the data rate of the interconnect such that each first datagram is packed into the corresponding second datagram.

In some embodiments, the second datagram includes a variable length. In some embodiments, the alignment markers of the second datagram are originally aligned in accordance with a pre-existing communication standard. In some embodiments, the alignment markers of the second datagram are realigned in accordance with a boundary of the first datagram.

Techniques operating according to the principles described herein can be implemented in any suitable manner. While the foregoing disclosure sets forth some examples using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered as non-limiting examples since many other architectures can be implemented to achieve the same functionality.

Included in the discussion above are flowcharts showing steps and acts in accordance with the techniques described herein. The processing and decision blocks of the flowcharts above represent steps and acts that can be included in algorithms that carry out these processes. Algorithms derived from these processes (or steps thereof) can be implemented as software integrated with and directing the operation of one or more single- or multi-purpose processors (e.g., central processing units (CPUs), graphics processing units (GPUs), tensor processing units (TPUs), hardware accelerators, etc.), can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flowchart(s) included herein do not depict the syntax or operation of any particular circuit or of any particular programming language or type of programming language. Rather, the flowchart(s) illustrate the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flowchart is merely illustrative of the algorithms that can be implemented and can be varied in implementations and embodiments of the principles described herein.

Accordingly, in some embodiments, the techniques described herein can be embodied in computer-executable instructions implemented as software, including as application software, system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative embodiments, be adapted to interact with other, unrelated functional facilities and/or processes, to implement a software program application. In other implementations, the functional facilities can be adapted to interact with other functional

facilities in such a way as form an operating system, including the Windows® operating system, available from the Microsoft® Corporation of Redmond, Washington. In other words, in some implementations, the functional facilities can be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that can implement the exemplary techniques described herein, and that embodiments are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

Computer-executable instructions implementing the techniques described herein (when implemented as one or more functional facilities or in any other manner) can, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as system memory, accelerator memory, and/or system memory of the system 400 of FIG. 4 or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

In some, but not all, implementations in which the techniques can be embodied as computer-executable instructions, these instructions can be executed on one or more suitable computing device(s) operating in any suitable computer system, or one or more computing devices (or one or more processors of one or more computing devices) can be programmed to execute the computer-executable instructions. A computing device or processor can be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

Embodiments have been described where the techniques are implemented in circuitry and/or computer-executable instructions. It should be appreciated that some embodiments can be in the form of a method, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments.

Various aspects of the embodiments described above can be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment can be combined in any manner with aspects described in other embodiments.

Throughout the specification and claims, the following terms take the meanings explicitly associated herein, unless the context clearly dictates otherwise. The phrases "in one embodiment," “in an embodiment,” and "in some embodiments" as used herein do not necessarily refer to the same embodiment(s), though it may. Furthermore, the phrases "in another embodiment" and "in some other embodiments" as used herein do not necessarily refer to a different embodiment, although it may. All embodiments of the disclosure are intended to be combinable without departing from the scope or spirit of the disclosure.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Unless otherwise noted, the terms “connected to” and “coupled to” (and their derivatives), as used in the specification and claims, are to be construed as permitting both direct and indirect (i.e., via other elements or components) connection.

Unless otherwise noted, a first numeric value is “approximately” equal to a second numeric value if the first numeric value is within + 20%, + 10%, or + 5% of the second numeric value.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. An apparatus for data communication between link partners over an interconnect link, comprising:
at least one circuit comprising:
a first circuit corresponding to a data link layer, and
a second circuit corresponding to a physical layer, the second circuit comprising:
a first sublayer,
a second sublayer located between the first sublayer and the interconnect link, and
an interface communicatively coupling the first sublayer to the second sublayer for transmission of code blocks between the first and second sublayers during data communications between the link partners, the code blocks configured to align a first datagrams of the first sublayer to a second datagrams of the second sublayer based on alignment markers of the second datagrams.

2. The apparatus according to claim 1, wherein, in a transmit direction, the first sublayer sends a first code blocks to the second sublayer to indicate when to overwrite the alignment markers of the second datagrams.

3. The apparatus according to claim 2, wherein, based on the first code blocks from the first sublayer, the second sublayer transmits a modified second datagrams comprising alignment markers in the first four to sixteen code blocks according to a function of the second sublayer.

4. The apparatus according to claim 2, wherein the first code blocks comprise start flit code sequences.

5. The apparatus according to claim 1, wherein, in a receive direction, the second sublayer sends a second code blocks to indicate when the first datagrams comprise alignment markers.

6. The apparatus according to claim 5, wherein the second code blocks indicate the second sublayer is expected to, or receives, second datagrams comprising the alignment markers, and
wherein the second sublayer replaces a portion of the second datagrams comprising the alignment markers with the second code blocks.

7. The apparatus according to claim 5, wherein the second code blocks comprise alignment marker flit code sequences.

8. The apparatus according to claim 5, wherein the second sublayer replaces a portion of the second datagrams comprising the alignment markers with the second code blocks prior to forward error correction decode.

9. The apparatus according to claim 1, wherein the second code blocks are configured to align the first datagrams to a start of the second datagrams based on the alignment markers of the second datagrams to improve latency and replay bandwidth.

10. A system comprising:
a plurality of processors comprising a first processor in communication with at least one second processor over an interconnect fabric; and
at least one circuit comprising:
a first circuit corresponding to a data link layer, and
a second circuit corresponding to a physical layer, the second circuit comprising:
a first sublayer circuit,
a second sublayer circuit located between the first sublayer circuit and the interconnect fabric, and
an interface communicatively coupling the first sublayer circuit to the second sublayer circuit for transmission of code blocks between the first and second sublayer circuits during data communications between the first processor and the at least one second processor, the code blocks configured to align a first datagrams of the first sublayer circuit to a second datagrams of the second sublayer circuit based on alignment markers of the second datagrams.

11. The system according to claim 10, wherein, in a transmit direction, the first sublayer circuit sends a first code blocks to the second sublayer circuit to indicate when to overwrite the alignment markers of the second datagrams;
wherein, in a receive direction, the second sublayer circuit sends a second code blocks to indicate when the first datagrams comprise alignment markers.

12. The system according to claim 11, wherein, based on the first code blocks from the first sublayer circuit, the second sublayer circuit transmits a modified second datagrams comprising alignment markers in the first four to sixteen code blocks according to a function of the second sublayer circuit;
wherein the first code blocks comprise start flit code sequences.

13. The system according to claim 11, wherein the second code blocks indicate the second sublayer circuit is expected to, or receives, second datagrams comprising the alignment markers;
wherein the second sublayer circuit replaces a portion of the second datagrams comprising the alignment markers with the second code blocks; and
wherein the second code blocks comprise alignment marker flit code sequences.

14. The system according to claim 13, wherein the second sublayer circuit replaces a portion of the second datagrams comprising the alignment markers with the second code blocks prior to forward error correction decode.

15. The system according to claim 10, wherein the second code blocks are configured to align the first datagrams to a start of the second datagrams based on the alignment markers of the second datagrams to improve latency and replay bandwidth.

16. A method for data transmission between link partners over an interconnect link, the method comprising:
receiving a data stream for transmission between a first circuit and a second circuit over an interface coupled to the first circuit and the second circuit, the first circuit comprising a first datagrams and the second circuit comprising a second datagrams;
transmitting, based on the data, one or more code blocks from the first circuit or the second circuit to the other of the first circuit or the second circuit over the interface; and
aligning, based on the one or more code blocks, each first datagram to a corresponding second datagram based on alignment markers of the corresponding second datagram, wherein the aligning comprising at least one of:
overwriting, in a transmit direction, an alignment marker of the corresponding second datagram by the second circuit based on the one or more code blocks, or
converting, in a receive direction, the corresponding second datagram including the alignment marker with the one or more code blocks by the second circuit, wherein the first circuit aligns each first datagram to the converted second datagram based on the one or more code blocks;
wherein the first datagrams are data link flow control units and the second datagrams are codewords.

17. The method according to claim 16, wherein, in the transmit direction, the second circuit overwrites the alignment marker of the corresponding second datagram based on one or more first code blocks; and
wherein the first code blocks are start flit code sequences.

18. The method according to claim 16, wherein, in the receive direction, the second circuit converts the corresponding second datagram including the alignment marker with one or more second code blocks; and
wherein the second code blocks are AM flit code sequences.

19. The method according to claim 16, wherein, in the transmit direction, the first circuit transmits the one or more code blocks at an interval for the second circuit to transmit alignment markers as a function of data rate of the interconnect; and
wherein the second circuit overwrites a first n blocks of the corresponding second datagram as a function of the data rate of the interconnect such that each first datagram is packed into the corresponding second datagram.

20. The method of claim 16, wherein the second datagram comprises a variable length;
wherein the alignment markers of the second datagram are originally aligned in accordance with a pre-existing communication standard; and
wherein the alignment markers of the second datagram are realigned in accordance with a boundary of the first datagram.
